(19) United States
(12) Patent Application Publication
(10) Pub. No.: US 2008/0095133 A1
(43) Pub. Date: Apr. 24, 2008

(54) Method for reducing inter-cell interference in communications system

(76) Inventors: Shu Kodo, Miyamae-ku (JP); Chen Hongyuan, Tokyo (JP); Kari Sipila, Vantaa (FI); Preben Mogensen, Gistrup (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/584,553

(22) Filed: Oct. 23, 2006

(51) Int. Cl. H04B 7/216

(52) U.S. Cl. 370/342

(57) ABSTRACT

The application discloses a method for avoiding inter-cell interference in a cellular communications system. In the method, a user terminal (UE2) measures (6-3) control signalling (6-2) of a first, serving base station (BS3) and control signalling (6-1) of a second base station (BS2), the user terminal (UE2) being within the coverage area of the serving base station (BS3) and the coverage area of the second base station (BS2). Based on the measuring, the user terminal calculates (6-4) a timing difference between the signalling from the serving base station (BS3) and the signalling from the second base station (BS2). Information on the timing difference is provided (6-5) to the serving base station (BS3). Based on the timing difference, the serving base station (BS3) schedules (6-6) data transmission (6-7) to be transmitted to the user terminal (UE2) non-simultaneously with the control signalling (6-1) from the second base station (BS2).

### FIELD OF THE INVENTION

The present invention relates to reducing cell interference in a cellular system and more particularly to reducing inter-cell interference.

### BACKGROUND OF THE INVENTION

In a situation where a user terminal is served by a serving base station and located within a coverage area of two or more neighbouring base stations, the neighbouring base station(s) may cause inter-cell interference on the transmission from the serving base station to the user terminal.

In the Global System for Mobile Communications (GSM), frequency reuse is a method for expanding the capacity of a given set of frequencies or channels by separating the signals either geographically or by using of different polarisation techniques. The capacity of a GSM network can be increased by decreasing a value of a frequency reuse factor. However, a small frequency reuse factor increases the level of inter-cell interference in the network. In 3^{rd} Generation (3G) and in its evolution techniques (also referred to as “beyond-3G systems”), the frequency reuse method clearly differs from that of the GSM. In 3G and beyond systems, the value of the frequency reuse factor is assumed to be 1, i.e. every cell uses the same frequency. In 3G and beyond systems, a certain level of interference control is required for optimizing the functioning of the radio access network.

In order to reduce inter-cell interference or co-channel interference in a frequency reuse-1 cellular network, power-sequence-based interference control (PSEQ-IC) or static soft-reuse interference control have been suggested. In that case, a base station transmits at certain transmission power levels, defined by a power sequence, in certain time-frequency resource blocks. Adjacent base stations are arranged to use different power sequences to avoid peaks in downlink transmission powers transmitted in the same time-frequency resource blocks. The layer-1 common control channels usually use the maximum power for transmission in order to serve all user terminals located in the cell area. The time-frequency resource blocks reserved for the layer-1 common control channels may be the same in every cell; for example, the 1st symbol of the radio frame and/or the middlemost 1.25 MHz may be reserved for layer-1 common control channels in the beyond-3G systems.

One of the problems associated with the above arrangement is that the traffic channel (or shared data channel in the scope of Long Term Evolution (LTE) systems) of a serving cell is severely interfered because the common control channels transmit at maximum power in the neighbouring cells. Assuming that power-sequence-based interference control is applied, the severe interference is true especially for the mobile terminals at a cell-edge, because they are scheduled to the time-frequency resource blocks with the highest power and expect the neighbouring cells to transmit at a lower power in the same time-frequency resource blocks.

Regarding existing methods for inter-cell interference control (IC) of user data transmission, interference mitigation schemes, such as soft-reuse interference control, have been proposed. Those interference control schemes do not, however, relate to the inter-cell interference from the layer-1 common control channels, but the inter-cell interference between the traffic channels.

### BRIEF DESCRIPTION OF THE INVENTION

An object of the present invention is thus to provide a method and an arrangement for implementing the method so as to solve the above problems. The objects of the invention are achieved by a method, system, base station and user terminal, which are characterized by what is stated in the independent claims. Embodiments of the invention are disclosed in the dependent claims.

The present solution is based on a method for avoiding inter-cell interference in a cellular communications system. In the method, a user terminal measures a frame and/or symbol timing of a first, serving base station and a frame and/or symbol timing of a second base station, the user terminal being located within the coverage area of the serving base station and the coverage area of the second base station. On the basis of the measuring, a timing difference between first signalling from the serving base station to the user terminal and second signalling from the second base station to the user terminal is calculated. Information on the calculated timing difference is provided to the serving base station. As the timing difference information is received at the serving base station, the serving base station schedules data transmission from the serving base station to the user terminal to be carried out non-simultaneously with control signalling from the second base station to the user terminal.

An advantage of the method and arrangement of the invention is that the interference from layer-1 common control channels of neighbouring cells in beyond-3G cellular radio networks can be avoided. An advantage of the present solution is that existing handover procedure signalling between the user terminal and the base stations in can be utilized. By means of the invention, the cell throughput can be improved, as the number of failed user data transmissions can be decreased.

### BRIEF DESCRIPTION OF THE DRAWINGS

In the following the invention will be described in greater detail by means of preferred embodiments with reference to the attached drawings, in which

FIG. 1 illustrates a cellular communications system according to the present invention;

FIG. 2 illustrates inter-cell interference from common control channels;

FIG. 3 illustrates inter-cell interference from common control channels to traffic channels;

FIG. 4 illustrates obtaining of frame offset according to the present invention;

FIG. 5 illustrates the method according to an embodiment of the present invention;

FIG. 6 is a signalling chart illustrating the method according to an embodiment of the present invention;

FIG. 7 is a flow chart illustrating the functioning of a user terminal according to an embodiment of the present invention;

FIG. 8 is a flow chart illustrating the functioning of a base station according to an embodiment of the present invention.

### DETAILED DESCRIPTION OF THE INVENTION

In the following, preferred embodiments of the invention will be described with reference to a third generation mobile communications system, such as the UMTS (Universal Mobile Communications System). This invention is not, however, meant to be restricted to these embodiments. Consequently, the invention may be applied in any cellular communications system that provides packet switched radio service capable of layer-1 common control signalling. Examples of other systems include the IMT-2000 and its evolution techniques (such as Beyond-3G including LTE (3.9G) and 4G). The specifications of mobile communications systems advance rapidly. This may require additional changes to the invention. For this reason, the terminology and the expressions used should be interpreted in their broadest sense since they are meant to illustrate the invention and not to restrict it. The relevant inventive aspect is the functionality concerned, not the network element or equipment where it is executed.

The present application relates to inter-cell interference (ICI) from layer-1 (L1) common control channels to layer-1 traffic channels. It discloses a method for avoiding interference in a traffic channel (or a shared data channel in an LTE system) from layer-1 common control channels of neighbour cells. Herein, the layer-1 common control channels refer to a L1 Synchronization (Sync) Channel, L1 Broadcast Channel (BCH), L1 Pilot Channel, and/or L1 Shared Control Channel.

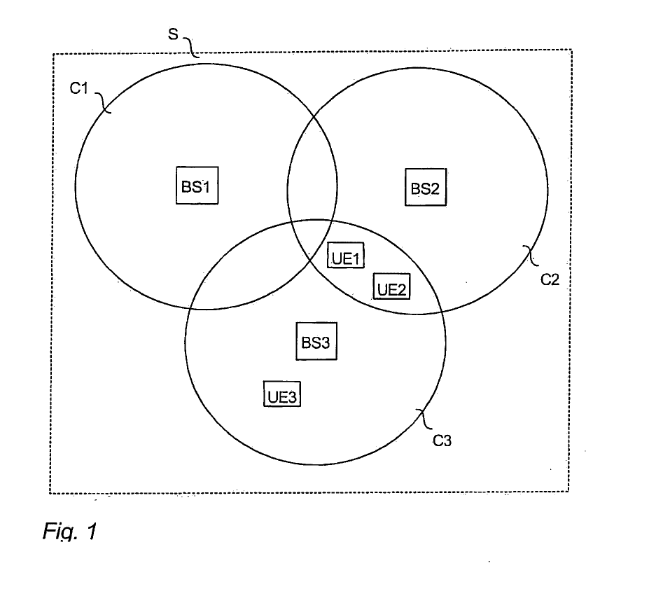

FIG. 1 illustrates a cellular communications system S according to the present solution. The system S comprises base stations BS1, BS2, BS3 and respective cells C1, C2, C3. A first base station BS1 is capable of transmitting signalling and user data within its coverage area, i.e. in a first cell C1. A second base station BS2 is capable of transmitting signalling and user data within its coverage area, i.e. in a second cell C2. A third base station BS3 is capable of transmitting signalling and user data within its coverage area, i.e. in a third cell C3. The system further comprises user terminals UE1, UE2, UE3. In the situation shown in FIG. 1, a first user terminal UE1 is located in the area of C2 and C3; a second user terminal UE2 is located in the area of C2 and C3; and a third user terminal UE3 is located in the area C3.

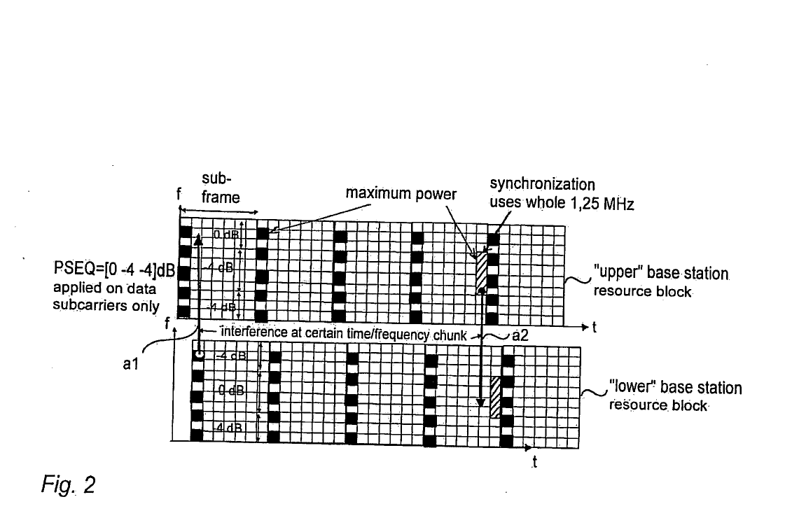

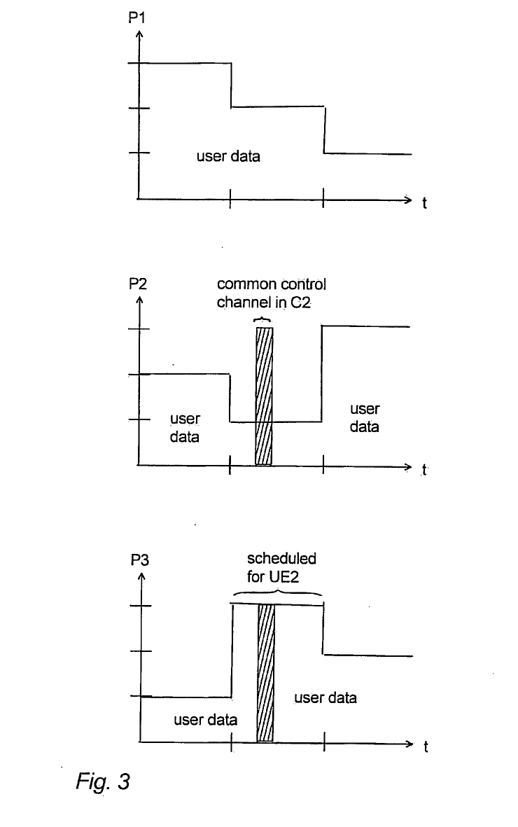

In prior art systems, if the second user terminal UE2 is served by the third base station BS3, scheduled data transmission from BS3 to UE2 is severely interfered by common control channel signalling transmitted at maximum power from the second base station BS2. (Because the common control channels are usually modulated/coded in a robust fashion the interference caused by scheduled data transmission to common control channels is a minor issue). Inter-cell interference caused in prior art systems to scheduled data transmission from BS3 to UE2 by common control channel signalling from BS2 is further illustrated in FIGS. 2 and 3.

FIG. 2 illustrates inter-cell interference caused to L1 traffic (i.e. data) channels by L1 common control channels of neighbour cells. In FIG. 2, “0 dB” represents maximum transmission power used on the traffic/data channels. Sub-carriers represent different parts of a cell spectrum. Inter-cell interference occurs in asynchronous systems, as shown in FIG. 1. For example, L1 synchronization channel transmits at maximum power, which may “destroy” data packets transmitted in other cells in the same time-frequency resource blocks. However, the problem is also relevant in synchronous systems, due to a location of the user terminal having a relative distance difference between a serving base station and an interfering base station. FIG. 2 shows an example of time-frequency resource blocks of two base stations. A first arrow a1 points out the interference caused by the control channel of a “lower” base station to the data channel of an “upper” base station, wherein the upper base station uses maximum power for covering its cell edge UE, but the lower base station transmits control information using maximum power in the same time-frequency resource block although this time-frequency resource block is supposed to be −4 dB for the lower base station. A second arrow a2 shows the interference caused by the synchronization channel of the upper base station to the lower base station, wherein the lower base station uses maximum power for covering its cell edge UE, but the upper base station transmits synchronization information using maximum power in the same time-frequency resource block, although this time-frequency resource block is supposed to be −4 dB for the upper base station.

FIG. 3 shows transmission powers P1, P2, P3 of the respective base stations BS1, BS2, BS3, as functions of time t. As shown in FIG. 3, the common control signalling from BS2 is transmitted in the same time frame (i.e. simultaneously) in which scheduled user data is transmitted from BS3 to UE2, thus causing severe interference.

The present solution is intended for asynchronous systems, but it may also be utilized in synchronous systems. In the scope of long term evolution (LTE) discussions in the 3GPP, the common control channels usually have fixed positions in the radio frames. For example, the 1st symbol of the radio frame is reserved for an L1 pilot channel, and the centremost 1.25 MHz is reserved for an L1 synchronization channel. The synchronization channel appears at the end of the sub-frame in every 4 sub-frame in LTE. However, in the following, the present solution will be explained in terms of an L1 pilot channel and/or an L1 shared control channel that appear at the beginning of every radio frame. The present solution can be applied to an L1 synchronization channel and L1 broadcast channel (BCH) as well, as the user terminal obtains the timing position of the L1 synchronization channel of the neighbour cells when carrying out the handover measurements.

When a mobile user terminal UE2 is located within the coverage of both a serving cell C3 and a neighbour cell C2, the user terminal UE2 carries out handover measurements. When carrying out the handover measurements, UE2 has to synchronize itself to the neighbour cell C2 and measure levels of handover measurement quantities (e.g. PSSI (Pilot Signal Strength Indicator)). The synchronization enables the user terminal to detect the timing difference (and/or frame offset) between the neighbour cell C2 and the serving cell C3, as UE2 obtains a frame and/or symbol timing (i.e. the timing of a certain symbol, or the timing of a certain frame, or both) of both the serving cell C3 and the neighbour cell C2.

According to a conventional handover measurement procedure, the user terminal UE2 reports the measured levels of handover measurement quantities (e.g. PSSI) to the serving BS3. The reporting is carried out every 200 ms, for example. In the present solution, UE2 is further arranged to calculate a frame offset and report it to the serving BS3, for example, in an RRC message related to the handover measurement procedure. The obtained frame offset does not have to be very accurate; for example, a symbol-based accuracy may be enough. Therefore, assuming that a single radio frame (sub-frame in LTE systems) contains 7 symbols, 3 bits are enough for indicating relative positions. In order to carry out mobility measurements, the user terminal is arranged to identify and/or measure the signal strength and/or the timing of the neighbour cell and the serving cell.

On the basis of the frame offset information received from UE2, the serving BS3 stores and/or updates a relative frame offset between BS3 and BS2. Table 1 shows a frame offset table that can be maintained at the serving BS3 for each user terminal and/or each group of user terminals. Since L1 common control channels are transmitted at the beginning of a radio frame (usually as the 1st symbol of the frame), the serving BS3 obtains the timing positions of the common control channel of the neighbour cells by using the frame offsets. Table 1 is an example of a frame offset table (at symbol accuracy) maintained in the serving BS3 for individual user terminals or individual groups of user terminals. Here “0” implies that the timing of the serving BS3 and the neighbouring base station match each other (in full synchronization) for the user terminal (or group of user terminals). It is assumed that a radio frame consists of 7 symbols. The idea is that non-suitable time-slots can be detected, and they are marked with “X”.

TABLE 1

Time slot

| | | | | |
|---|---|---|---|---|
| Frame offset | 0 | 1 | . . . | 6 |
| relative to base | | | | |
| station [symbol] | | | | |
| UE1 (or group | X | | | |
| 1) | | | | |
| UE2 (or group | | X | | |
| 2) | | | | |
| . . . | | | | |

The user terminals in the frame offset table may also be selected such that the user terminal is included in the frame offset table if the strongest neighbouring base station is within an x dB window relative to its serving base station. Here x dB can be a selected implementation parameter (which is not necessarily a handover window parameter).

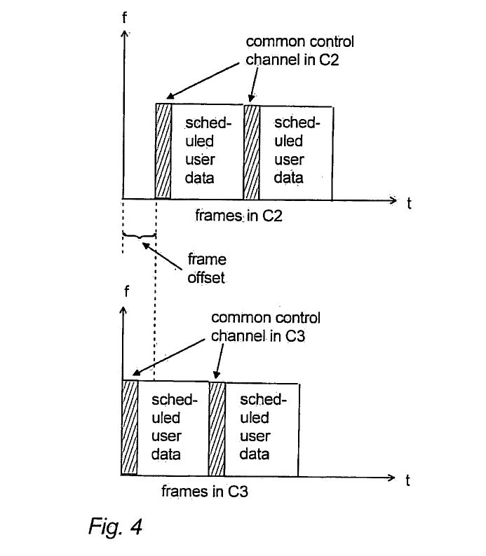

FIG. 4 illustrates the obtaining of the frame offset (frequency f as a function of time t) from the user terminals, wherein UE1 reports the frame offset between C3 and C2 to BS2, and UE2 reports the frame offset between C2 is and C3 to BS3.

When a power sequence operates at maximum power level in certain time-frequency resource blocks, the serving base station BS3 checks the frame offset table before scheduling the user terminals. The base station BS3 scheduler implements an “inverse muting” action according to the present solution, wherein BS3 avoids scheduling “collision” time-frequency resource blocks (or symbols) for the user terminal (or the group of terminals), in which blocks the user terminal would suffer from inter-cell interference caused by a common control channel of a neighbour cell. Instead, BS3 schedules these symbols for another user terminal (or another group of terminals).

According to an embodiment, the second symbol in the radio frame are not scheduled for UE2 (or UE group 2), but other symbols in the radio frame are scheduled for UE2 (or UE group 2) instead. In that case, it is not necessary to change the power sequence itself. For those time-frequency resource blocks that do not transmit at maximum power, the BS3 scheduler does not check its frame-offset table but schedules the users normally.

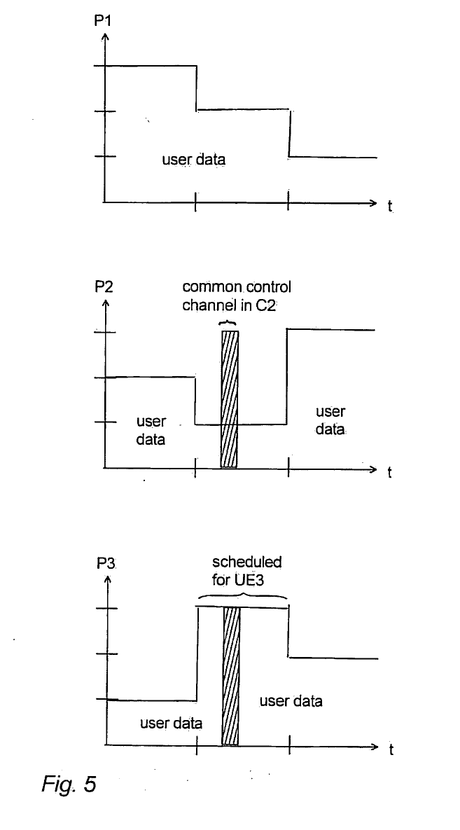

FIG. 5 shows transmission powers P1, P2, P3 of the respective base stations BS1, BS2, BS3, as functions of time t in a situation where the present solution is applied. In FIG. 5, as common control signalling is transmitted from BS2 in C2, the third base station BS3 is arranged to transmit scheduled user data to UE3 (instead of UE2). Thus, the inter-cell interference can be avoided, as UE3 is currently located outside the coverage area of BS2 (i.e. UE3 is unable to receive any signalling from BS2).

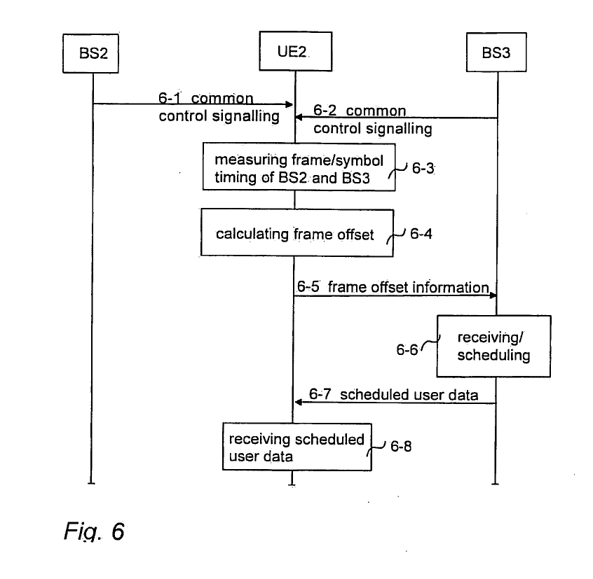

FIG. 6 is a signalling chart illustrating the method according to an embodiment of the present invention. In FIG. 6, common control signalling is transmitted 6-1, 6-2 to a user terminal UE2 from a first base station BS3 serving the user terminal UE2 and from a second base station BS2. In step 6-3 the common control signalling is received by the user terminal UE2, and the frame and/or symbol timing is measured by UE2. In FIG. 6, it is assumed that the user terminal UE2 is located within the coverage area C3 of the serving base station BS3 and within the coverage area C2 of the second base station BS2. On the basis of the measured frame/symbol timing UE2 calculates, in step 6-4, a timing difference (and/or a frame offset) between the signalling received from the serving base station and the signalling received from the second base station. After that, information on the timing difference (and/or frame offset) is provided in a message 6-5 from the user terminal UE2 to the serving base station BS3. (Message 6-5 may include an additional RRC message (or additional 3 bits) to be transmitted in the system S). In step 6-6, the information is received in the serving base station BS3. On the basis of the received information, BS3 is able to schedule user data transmission from BS3 to UE2 such that the common control signalling from BS2 does not interfere with the data transmission from BS3. This means that BS3 schedules, in step 6-6, the data transmission from BS3 to UE2 to be carried out non-simultaneously with the common control signalling from BS2 to UE2. In message 6-7, scheduled user data is transmitted from BS3 to UE2. In step 6-8, UE2 receives the scheduled user data from BS3.

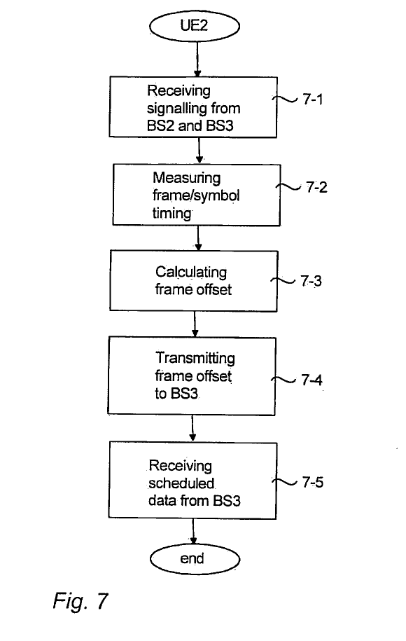

FIG. 7 is a flow chart illustrating the functioning of the user terminal UE2 located within the coverage area C3 of a first serving base station BS3 and the coverage area C2 of a second base station BS2, according to an embodiment of the present invention. In step 7-1, common control signalling is received in the user terminal UE2 from the serving base station BS3 and from the second base station BS2. In step 7-2, UE2 measures the frame and/or symbol timing of the received common control signalling. On the basis of the measured frame/symbol timing UE2 calculates, in step 7-3, a timing difference (and/or a frame offset) between the signalling received from the serving base station and the signalling received from the second base station. After that, information on the timing difference (and/or frame offset) is transmitted, in step 7-4, to the serving base station BS3. In step 7-5, UE2 receives scheduled user data from BS3.

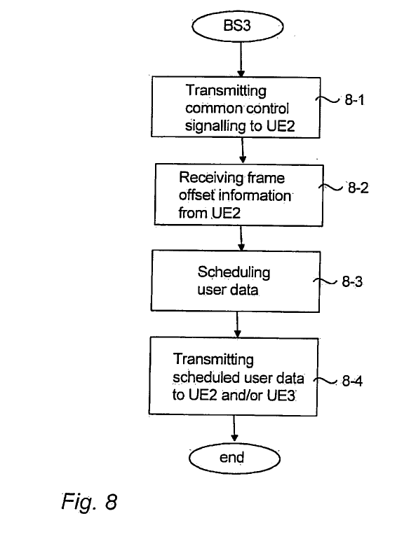

FIG. 8 is a flow chart illustrating the functioning of a base station BS3 according to an embodiment of the present invention. BS3 transmits, in step 8-1, common control signalling to a user terminal UE2 served by BS3 and located within the coverage area C3 of BS3. In step 8-2, BS3 receives information on a timing difference (and/or a frame offset) between signalling received in UE2 from BS3 and from a second base station BS2. On the basis of the received information, BS3 is able to schedule user data transmission from BS3 to UE2 such that the common control signalling from BS2 does not interfere with the data transmission from BS3. This means that BS3 schedules, in step 8-3, the data transmission to UE2 to be carried out non-simultaneously with the common control signalling from BS2 to UE2. In step 8-4, BS3 transmits scheduled user data to UE2. BS3 may also transmit user data to a third user terminal UE3.

It should be noted that the present solution is also applicable to systems in which no power sequence is applied. In that case, the implementation is as follows: when the base station is ready for scheduling a new frame, the base station obtains a relative timing position of a common control channel of neighbour cells via user terminal measurements. Then, the base station avoids a “collision” timing with common control channels of the neighbour cells when scheduling the user terminals.

The present solution is primarily intended for operations on the physical layer (i.e. on the layer-1 packet scheduler) and for radio resource management (RRM). The present solution enables improving cell throughput by avoiding a “collision” timing with common control channels of neighbour cells when scheduling the user terminals. The present solution does not require changing the static soft-reuse IC schemes (such as PSEQ-IC). No new signalling is required between neighbouring base stations. Existing prior art signalling related to the handover measurement procedure can also be utilized between the base station and the user terminal. The present solution can also be implemented in systems that do not apply PSEQ-IC.

The items and steps shown in the figures are simplified and aim only at describing the idea of the invention. Other items may be used and/or other functions carried out between the steps. The items serve only as examples and they may contain only some of the information mentioned above. The items may also include other information, and the titles may deviate from those given above. Instead of or in addition to a base station, above described operations may be performed in any other element of a cellular communications system.

In addition to prior art means, a system or system network nodes that implement the functionality of the invention comprise means for processing information relating to reducing inter-cell interference as described above. Existing network nodes and user terminals comprise processors and memory that can be utilized in the operations of the invention. Any changes needed in implementing the invention may be carried out using supplements or updates of software routines and/or routines included in application specific integrated circuits (ASIC) and/or programmable circuits, such as EPLDs (Electrically Programmable Logic Device) or FPGAs (Field Programmable Gate Array).

It will be obvious to a person skilled in the art that as technology advances, the inventive concept can be implemented in various ways. The invention and its embodiments are not limited to the examples described above but may vary within the scope of the claims.

1. A method for avoiding inter-cell interference in a cellular communications system, the method comprising steps of
transmitting first control signalling from a serving base station to a first user terminal, wherein the first user terminal is located within the coverage area of the serving base station and the coverage area of a second base station;
in the serving base station, receiving, from the first user terminal, information on a timing difference between the first control signalling and second control signalling, the second control signalling being transmitted from the second base station to the first user terminal; and
on the basis of the received information, scheduling data transmission to the user terminal to be carried out non-simultaneously with the second control signalling.

2. A method according to claim 1, wherein the data transmission from the serving base station to the first user terminal and the control signalling from the second base station to the first user terminal are scheduled to be carried out in different time slots.

3. A method according to claim 1, wherein it comprises scheduling data transmission from the serving base station to a second user terminal to be carried out simultaneously with control signalling from the second base station to the first user terminal, said second user terminal being located within the coverage area of the serving base station but outside the coverage area of the second base station.

4. A method as claimed in claim 1, wherein the method comprises adjusting the scheduling of the user data transmission from the serving base station to the first user terminal such that a collision with the control signalling from the second base station to the first user terminal is avoided.

5. A method as claimed in claim 1, wherein said measuring comprises handover measurements.

6. A method as claimed in claim 1, wherein said information on the timing difference comprises information on a frame offset between the control signalling of the serving base station and the control signalling of the second base station.

7. A method according to claim 1, wherein said control signalling comprises common control channel signalling.

8. A method according to claim 1, wherein said control signalling comprises layer-1 common control channel signalling.

9. A method according to claim 1, wherein said user data transmission comprises traffic channel transmission.

10. A method according to claim 1, wherein said user data transmission comprises layer-1 traffic channel transmission.

11. A method for avoiding inter-cell interference in a cellular communications system, the method comprising steps of
receiving, in a first user terminal, first control signalling from a serving base station and second control signalling from a second base station, wherein the first user terminal is located within the coverage area of the serving base station and the coverage area of the second base station;
on the basis of the received first and second control signalling, measuring at least one of a frame timing and a symbol timing for the serving base station and for the second base station;
on the basis of said measuring, calculating a timing difference between the first and the second control signalling;
providing, to the serving base station, information on said timing difference;
receiving said information in the serving base station; and
on the basis of the received information, scheduling data transmission from the serving base station to the first user terminal to be carried out non-simultaneously with control signalling from the second base station to the first user terminal.

12. A method according to claim 11, wherein it comprises measuring the frame timing and the symbol timing, for the serving base station and for the second base station.

13. A method according to claim 11, wherein it comprises receiving, in the first user terminal, scheduled user data from the serving base station non-simultaneously with control signalling from the second base station.

14. A method according to claim 11, wherein the data transmission from the serving base station to the first user terminal and the control signalling from the second base station to the first user terminal are scheduled to be carried out in different time slots.

15. A method according to claim 11, wherein it comprises scheduling data transmission from the serving base station to a second user terminal to be carried out simultaneously with control signalling from the second base station to the first user terminal, said second user terminal being located within the coverage area of the serving base station but outside the coverage area of the second base station.

16. A method as claimed in claim 11, wherein the method comprises adjusting the scheduling of the user data transmission from the serving base station to the first user terminal such that a collision with the control signalling from the second base station to the first user terminal is avoided.

17. A cellular communications system comprising a first user terminal located within the coverage area of a serving base station and the coverage area of a second base station, wherein the first user terminal is configured to receive first control signalling from the serving base station and second control signalling from the second base station, wherein the cellular communications system is configured to
measure, on the basis of the received first and second control signalling, at least one of a frame timing and a symbol timing, for the serving base station and for the second base station;
calculate, on the basis of the measuring, a timing difference between the first and second control signalling;
provide, to the serving base station, information on said timing difference; and
schedule, on the basis of said information, data transmission from the serving base station to the first user terminal to be carried out non-simultaneously with control signalling from the second base station to the first user terminal.

18. A system according to claim 17, wherein it is configured to measure the frame timing and the symbol timing, for the serving base station and for the second base station.

19. A system according to claim 17, wherein it is configured to schedule data transmission from the serving base station to a second user terminal to be carried out simultaneously with the second control signalling.

20. A system according to claim 17, wherein it is a synchronous system.

21. A system according to claim 17, wherein it is an asynchronous system.

22. A system according to claim 17, wherein it is a beyond-3G system.

23. A base station in a cellular communications system, the base station being capable of serving a user terminal located within a coverage area of the base station and the coverage area of a second base station and arranged to transmit first control signalling to said user terminal, wherein the base station is configured to
receive, from the user terminal, information on a timing difference between the first control signalling and second control signalling, the second control signalling being transmitted from the second base station to the user terminal; and
on the basis of the received information, schedule data transmission to the user terminal to be carried out non-simultaneously with the second control signalling.

24. A base station according to claim 23, wherein it is configured to schedule data transmission to a second user terminal to be carried out simultaneously with the second control signalling, said second user terminal being located outside the coverage area of the second base station.

25. A user terminal in a cellular communications system, the user terminal being located within a coverage area of a serving base station and a coverage area of a second base station, wherein the user terminal is configured to receive first control signalling from the serving base station and second control signalling from the second base station, wherein the user terminal is further configured to
measure, on the basis of the received first and second control signalling, at least one of a frame timing and a symbol timing, for the serving base station and the second base station;
calculate, on the basis of the measuring, a timing difference between the first control signalling and the second control signalling; and
provide, to the serving base station, information on said timing difference.

26. A user terminal according to claim 25, wherein it is configured to measure the frame timing and the symbol timing, for the serving base station and for the second base station.

27. A user terminal according to claim 25, wherein it is configured to receive scheduled user data from the serving base station non-simultaneously with control signalling from the second base station.
